(19) United States
(12) Patent Application Publication
(10) Pub. No.: US 2026/0017557 A1
(43) Pub. Date: Jan. 15, 2026

(54) CONFIDENTIAL DISTRIBUTED MACHINE LEARNING

(71) Applicant: Robert Bosch GmbH, Stuttgart (DE)

(72) Inventors: Christian Zimmermann, Stuttgart (DE); Jared Weinfurtner, Bissingen An Der Teck (DE); Sebastian Becker, Ludwigsburg (DE); Sven Trieflinger, Renningen (DE)

(21) Appl. No.: 18/660,573

(22) Filed: May 10, 2024

(30) Foreign Application Priority Data
May 24, 2023 (DE) 10 2023 204 816.7

(51) Int. Cl. G06N 20/00; H04L 9/00; H04L 9/08

(52) U.S. Cl. CPC G06N 20/00; H04L 9/008; H04L 9/085

(57) ABSTRACT

A method comprising a computer-implemented method for federated learning for an owner of a machine learning model, a computer-implemented method for federated learning for an orchestrator, a computer-implemented method for federated learning for a training client, and/or a computer-implemented method for federated learning for an aggregator.

### CROSS REFERENCE

The present application claims the benefit under 35 U.S.C. § 119 of German Patent Application No. DE 10 2023 204 816.7 filed on May 24, 2023, which is expressly incorporated herein by reference in its entirety.

### BACKGROUND INFORMATION

Federated (machine) learning can be regarded as a subtype of distributed (machine) learning. In federated machine learning (see, for example, Priyanka Mary Mammen. 2021. “Federated Learning: Opportunities and Challenges;” in Proceedings of ACM Conference (Conference'17). ACM, New York, NY, USA, 5 pages; https://arxiv.org/pdf/2101.05428.pdf), several devices jointly learn a machine learning model, such as an artificial neural network, for example under the supervision of a central server, without sharing their private training data in the process. Federated (machine) learning can therefore, in particular, be used where the private training data must not be shared for data protection reasons (for example, in the healthcare sector, financial sector, etc.).

In federated learning, local machine learning model updates are generated by the local training procedures on the participating devices and are aggregated (i.e., combined) to a trained global machine learning model. An algorithm for secure aggregation is, for example, described in “SAFELearn: Secure Aggregation for private FEderated Learning,” Hossein Fereidooni et al, Cryptology ePrint Archive, Paper 2021/386; https://eprint.iacr.org/2021/386.

Trusted execution environments (TEE) provide a secure or trusted runtime environment for applications. One example of a TEE is Intel Software Guard Extensions (Intel SGX), see, for example, https://de.wikipedia.org/w/index.php?title=Software_Guard_Extensions&oldid=232528710. The concept of remote attestation is known in the context of trusted computing. It can, for example, be used to recognize changes to a user's computer by authorized parties, see, for example, https://en.wikipedia.org/w/index.php?title=Trusted_Computing&oldid=1151565594#Remote_attestation.

(Secure) multi-party computation (MPC) (in German approximately: (sichere) Mehrparteienberechnung) is likewise a subarea of cryptography with the aim of developing methods with which parties can jointly calculate a function via their input variables, wherein these input variables remain secret, see, for example, https://en.wikipedia.org/w/index.php?title=Secure_multi-party_computation&oldid=1148234769. Cloud native (secure) multi-party computation can be realized, for example, by Carbyne Stack, see, for example, https://carbynestack.io.

The present invention provides measures for improving the confidentiality in federated learning.

### SUMMARY

A first general aspect of the present invention relates to a computer-implemented method for federated learning for an owner of a machine learning model. According to an example embodiment of the present invention, the method comprises uploading a first secret sharing of a first multi-party computation (MPC) representation (CS(G_i)) of a machine learning model (G_i) to a cluster of an aggregator, wherein a first identifier (ID(CS(G_i))) for the first MPC representation (CS(G_i)) of the machine learning model (G_i) on the cluster of the aggregator is sent to the owner. The method furthermore comprises sending a first trigger signal comprising the first identifier (ID(CS(G_i))) to an orchestrator.

A second general aspect of the present invention relates to a computer-implemented method for federated learning for an orchestrator. According to an example embodiment of the present invention, the method comprises sending a second trigger signal comprising a first identifier (ID(CS(G_i))) for a first MPC representation (CS(G_i)) of a machine learning model (G_i) on a cluster of an aggregator to a plurality (C) of training clients (c_j) for a training iteration when a first trigger signal comprising the first identifier (ID(CS(G_i))) has been received. The method furthermore comprises sending a fourth trigger signal comprising a second identifier (ID(CS(L_i_j))) for a second MPC representation (CS(L_i_j)) of a local machine learning model update (L_i_j) on the cluster of the aggregator to the aggregator when at least one third trigger signal comprising the second identifier (ID(CS(L_i_j))) for the second MPC representation (CS(L_i_j)) of the local machine learning model update (L_i_j) on the cluster of the aggregator has been received.

A third general aspect of the present invention relates to a computer-implemented method for federated learning for a training client (c_j). According to an example embodiment of the present invention, the method comprises downloading a first MPC representation (CS(G_i)) of a machine learning model (G_i) from a cluster of an aggregator on the basis of a first identifier (ID(CS(G_i))) when a second trigger signal comprising the first identifier (ID(CS(G_i))) has been received and identity and permission of the training client (c_j) have been verified on the cluster of the aggregator. The method furthermore comprises converting the first MPC representation (CS(G_i)) of the machine learning model to a local machine learning model according to a predetermined MPC protocol. The method furthermore comprises training the local machine learning model on the basis of local training data of the training client, wherein a local machine learning model update (L_i_j) is generated. The method furthermore comprises converting the local machine learning model update (L_i_j) to a second MPC representation (CS(L_i_j)) according to the predetermined MPC protocol. The method furthermore comprises uploading a second secret sharing of the second MPC representation (CS(L_i_j)) of the local machine learning model update (L_i_j) to the cluster of the aggregator, wherein a second identifier (ID(CS(L_i_j))) for the second MPC representation (CS(L_i_j)) of the local machine learning model update (L_i_j) on the cluster of the aggregator is sent to the training client (c_j). The method furthermore comprises sending a third trigger signal comprising the second identifier (ID(CS(L_i_j))) to an orchestrator.

A fourth general aspect of the present invention relates to a computer-implemented method for federated learning for an aggregator. According to an example embodiment of the present invention, the method comprises sending a first identifier (ID(CS(G_i))) for a first MPC representation (CS(G_i)) of a machine learning model (G_i) on a cluster of the aggregator to an owner of the machine learning model (G_i) when a first secret sharing of the first MPC representation (CS(G_i)) is uploaded to the cluster of the aggregator. The method furthermore comprises sending a second identifier (ID(CS(L_i_j))) for a second MPC representation (CS(L_i_j)) of a local machine learning model update (L_i_j) on the cluster of the aggregator to a training client (c_j) when a second secret sharing of the second MPC representation (CS(L_i_j)) is uploaded to the cluster of the aggregator. The method furthermore comprises securely aggregating, when a fourth trigger signal is received, a local machine learning model update (L_i_j) with at least one further local machine learning model update on the basis of a predetermined MPC circuit, wherein a third secret sharing of a third MPC representation (CS(G_(i+1))) for an aggregated machine learning model (G_(i+1)) on a cluster of the aggregator and a third identifier (ID(CS(G_(i+1)))) for the third MPC representation (CS(G_(i+1))) result. The method furthermore comprises sending the third identifier (ID(CS(G_(i+1)))) to an orchestrator.

A fifth general aspect of the present invention relates to a method comprising the method according to the first general aspect of the present invention, the method according to the second general aspect of the present invention, the method according to the third general aspect of the present invention, and/or the method according to the fourth general aspect of the present invention.

A sixth general aspect of the present invention relates to an apparatus designed to perform a method according to one of the above-described general aspects of the present inventon.

A seventh general aspect of the present invention relates to a computer program designed to perform a method according to one of the above-described general aspects of the present invention.

An eighth general aspect of the present invention relates to a data carrier or signal that contains/encodes the computer program according to the seventh general aspect of the present invention.

In federated (machine) learning, a plurality, generally a multitude, of devices, hereinafter referred to as training clients, jointly trains a (global) machine learning model, such as an (artificial) neural network. The training clients do not have to be subject to the same responsibility. Instead, training clients may be located at different locations and/or subject to different responsibilities. An exemplary but not exclusive scenario comprises a respective (local) training client per clinic, wherein each client has (local) training data (for example, disease pictures, patient data, etc.) that it must not share with other clinics or instances, but is nevertheless willing to contribute to the training of the (global) machine learning model on the basis of these respective (local) training data. Generally, this can be achieved in that each (local) training client obtains a (global) machine learning model and generates, on the basis of its (local) training data, a (local) machine learning model update, in which the (global) machine learning model is, for example, respectively trained with the respective local training data on a training client. All (local) machine learning model updates are then aggregated by a central instance, which may be referred to as an aggregator, so that a (global) machine learning model update and, in particular, a trained (global) machine learning model results.

Since the participating training clients keep their respective (local) training data to themselves and do not pass them to third parties, federated learning is often regarded as a secure and privacy-friendly approach for the training of machine learning models with sensitive data.

However, it has been shown repeatedly (see, for example, Priyanka Mary Mammen. 2021. “Federated Learning: Opportunities and Challenges;” in Proceedings of ACM Conference (Conference'17). ACM, New York, NY, USA, 5 pages; https://arxiv.org/pdf/2101.05428.pdf and Benmalek et al., “Security of Federated Learning: Attacks, Defensive Mechanisms, and Challenges;” Revue des Sciences et Technologies de l'Information—Série RIA: Revue d'Intelligence Artificielle, 2022, 36 (1), pp.49-59, 10.18280/ria.360106, hal-0362040, https://hal.science/hal-03620400/document) that conventional federated learning is by far unable to fully ensure the confidentiality of local training data. In particular, the training data can be derived from machine learning model updates by a malicious aggregator. In addition, the global machine learning model may be susceptible to inference attacks, which are aimed at deriving training data from output data of a (locally) trained machine learning model.

A confidentiality attack may comprise a membership inference attack, which is aimed at determining whether certain training data have been utilized in the training by a training client. Alternatively, or additionally, a confidentiality attack may comprise an attribute inference attack, which is aimed at deriving meta-characteristics of training data of other training clients. Alternatively, or additionally, a confidentiality attack may comprise a reconstruction attack, which is aimed at reconstructing training data and/or associated labels that have been used in the training.

Thanks to the methods of the present invention, such confidentiality attacks on machine learning model updates can at least be made more difficult or entirely prevented. In addition to the confidentiality, the security can furthermore also be improved thanks to the methods of the present disclosure. In particular, the methods protect training clients from confidentiality attacks originating from a malicious aggregator and/or from a malicious orchestrator, wherein the orchestrator is designed to coordinate the federated learning.

### BRIEF DESCRIPTION OF THE DRAWINGS

FIG. 1A schematically illustrates a computer-implemented method for federated learning for an owner of a machine learning model, according to an example embodiment of the present invention.

FIG. 1B schematically illustrates a computer-implemented method for federated learning for an orchestrator, according to an example embodiment of the present invention.

FIG. 1C schematically illustrates a computer-implemented method for federated learning for a training client, according to an example embodiment of the present invention.

FIG. 1D schematically illustrates a computer-implemented method for federated learning for an aggregator, according to an example embodiment of the present invention.

FIG. 2 schematically illustrates a method comprising at least one method shown in FIGS. 1A-1D, according to an example embodiment of the present invention.

FIG. 3 schematically illustrates an owner of a machine learning model, an orchestrator, a training client, an aggregator, and, optionally, a tester, according to an example embodiment of the present invention.

### DETAILED DESCRIPTION OF EXAMPLE EMBODIMENTS

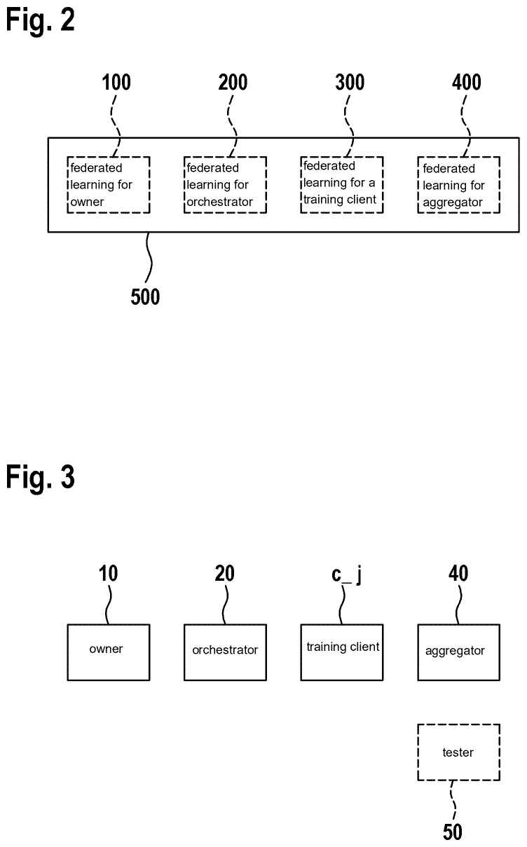

The computer-implemented methods proposed in the present disclosure are performed in interaction with the following entities, see FIG. 3: an owner of a machine learning model, a plurality (generally a multitude) of training clients, an orchestrator, and an aggregator. In addition, a tester may also be used.

The owner 10 of the (global) machine learning model has the rights to the (global) machine learning model, both in the initial state and in the trained state. In particular, the owner can select the machine learning model, i.e., its architecture (for example, number of neurons, layers, neurons per layer, etc.). At the same time, the owner is also the recipient of the federatedly trained machine learning model.

A training client c_j of the plurality/multitude C (i.e., j=1 to m) of training clients has (local) training data, which should at least not be shared with third parties or must not be shared with third parties. A training client may be a device (for example, a computer) within an organizational unit (for example, a clinic) that has (local) training data.

The orchestrator 20 coordinates the federated learning by triggering actions on the training clients c_j. The coordination comprises, for example, selecting training clients to be used in a next training iteration, providing references to the initial and updated (i.e., trained) machine learning model, and/or evaluating the training progress in a training iteration. Furthermore, the orchestrator delegates the aggregation 40 of the machine learning model updates of the training clients to the aggregator. Due to the communication via identifiers, the orchestrator never sees the machine learning model updates themselves or the machine learning model itself.

The aggregator 40 comprises a (secure) multi-party computation (MPC) cluster, i.e., in particular, a plurality of devices (for example, computers) configured for operations in the context of MPC. This means that each cluster member of the MPC cluster participates in the joint calculations of the cluster. The input of each individual cluster member comprises a secret portion of a secret sharing of a total input so that no individual cluster member gets to know the content of the total input, the content of its own secret portion, or the content of the portions of the other cluster members. The aggregator (i.e., the MPC cluster) obtains the machine learning model updates from the training clients, calculates the aggregated model update, and updates the global machine learning model accordingly. By utilizing (secure) multi-party computation (MPC), the aggregator advantageously has no knowledge of the model updates or of the global machine learning model.

The following conventions are used below:

G_i denotes a machine learning model, more specifically an i-th version of the machine learning model (for example, i=0 to n−1). G_0 may, for example, be an initial machine learning model for carrying out the disclosed methods. G_0 may, for example, be an untrained machine learning model. Alternatively, G_0 may be a machine learning model already previously trained by the disclosed methods or otherwise. G_i may, for example, be a data structure of the model parameters defining the machine learning model.

CS(x), for example for x=G_i or L_i_j, denotes a multi-party computation (MPC) representation of x. Such a representation is invertible, i.e., x can be converted to the MPC representation CS(x) according to a predetermined MPC protocol and the MPC representation CS(x) can likewise be converted to x according to the predetermined MPC protocol. CS(x) may, for example, be an MP-SPDZ/Carbyne Stack representation.

ID(y) is an identifier of a secret sharing y stored in the MPC cluster of the aggregator. In the case of Carbyne Stack, Amphora services can, for example, be used for cluster members.

L_i_j denotes a machine learning model update (locally) generated by a training client c_j in an i-th training iteration (for example, i=0 to n−1). A machine learning model update can, for example, be a machine learning model updated by training.

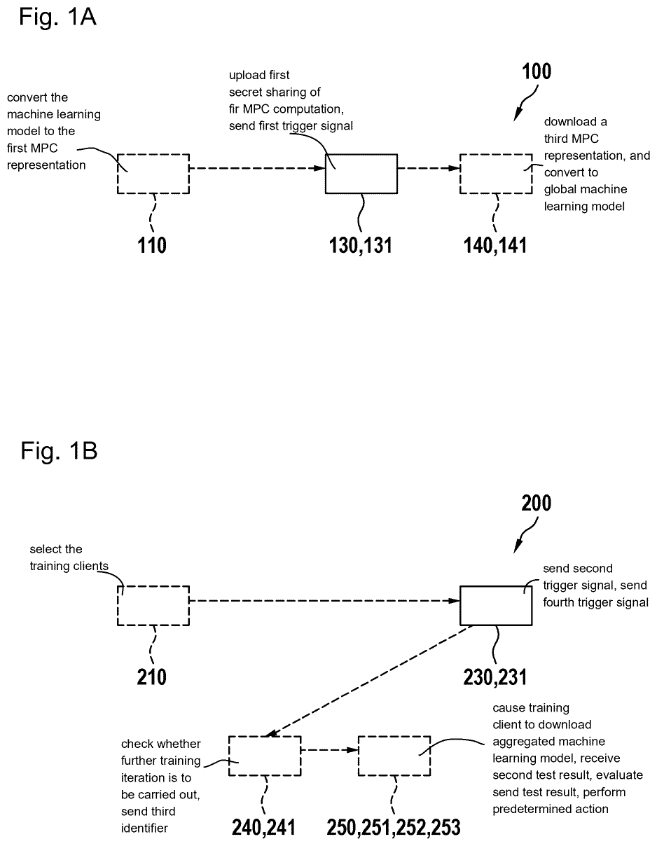

Disclosed first is a computer-implemented method 100 for federated learning for an owner 10 of a machine learning model, schematically shown in FIG. 1A.

The method 100 comprises uploading 130 a first secret sharing of a first multi-party computation (MPC) representation CS(G_i) of a (for example, initial) machine learning model G_i (i.e., for example, G_0) to a cluster of an aggregator 40, wherein a first identifier ID(CS(G_i)) for the first MPC representation CS(G_i) of the machine learning model G_i on the cluster 40 of the aggregator is sent to the owner 10. The uploaded 130 machine learning model may be an initial, i.e., an untrained, machine learning model (for example, G_0). Alternatively, the uploaded 130 machine learning model may be a machine learning model G_i that has already been trained at least partially.

The method 100 furthermore comprises sending 131 a first trigger signal comprising the first identifier ID(CS(G_i)) to an orchestrator 20. The first trigger signal can, for example, consist of only the first identifier ID(CS(G_i)). The first trigger signal can cause the orchestrator 20 to perform the federated learning on the training clients. One advantage of providing the machine learning model G_i as a secret sharing and otherwise only one identifier thereof can be that the orchestrator 20 does not obtain the machine learning model itself. This can better ensure the confidentiality of the machine learning model.

The method 100 can furthermore comprise converting 110 the (for example, initial) machine learning model G_i to the first MPC representation CS(G_i) according to a predetermined MPC protocol.

The method 100 can furthermore comprise downloading 140 a third MPC representation CS(G_(i+1)) of an aggregated machine learning model G_(i+1) from the cluster of the aggregator 40 on the basis of a third identifier ID(CS(G_(i+1))) for the third MPC representation CS(G_(i+1)) of the aggregated machine learning model G_(i+1) on the cluster of the aggregator 40 when the third identifier ID(CS(G_(i+1))) has been received. The method 100 can then furthermore comprise converting 141 the third MPC representation CS(G_(i+1)) of the aggregated machine learning model G_(i+1) to a global machine learning model according to the predetermined MPC protocol. Through steps 140 and 141, the owner of the machine learning model can retrieve the machine learning model in a trained state. In the case of, for example, n training iterations, CS(G_(n−1)) can also be downloaded first as the third MPC representation.

Furthermore disclosed is a computer-implemented method 200 for federated learning for an orchestrator 20, illustrated schematically in FIG. 1B.

The method 200 comprises sending 230 a second trigger signal comprising a first identifier ID(CS(G_i)) for a first MPC representation CS(G_i) of a machine learning model G_i on a cluster of an aggregator 40 to a plurality C (generally even a multitude) of training clients c_j for a training iteration when a first trigger signal comprising the first identifier ID(CS(G_i)) has been received. Through the second trigger signal, a training client c_j can in each case be caused to perform a training iteration. The second trigger signal can, for example, consist of only the first identifier ID(CS(G_i)). In general, both the orchestrator and each training client c_j know only the first identifier ID(CS(G_i)) but not the machine learning model G_i (or its MPC representation CS(G_i)). The latter is confidentially stored as a secret sharing on the cluster of the aggregator 40.

The method 200 can comprise selecting 210 the plurality/multitude C of the training clients c_j for the training iteration according to a predetermined selection strategy.

The method 200 furthermore comprises sending 231 a fourth trigger signal comprising a second identifier ID(CS(L_i_j)) for a second MPC representation CS(L_i_j) of a local machine learning model update L_i_j on the cluster of the aggregator 40 to the aggregator 40 when at least one third trigger signal comprising the second identifier ID(CS(L_i_j)) for the second MPC representation CS(L_i_j) of the local machine learning model update L_i_j on the cluster of the aggregator 40 has been received. The third trigger signal can, for example, consist of only the second identifier ID(CS(L_i_j)). Likewise, the fourth trigger signal can, for example, consist of only the second identifier ID(CS(L_i_j)).

The fourth trigger signal can be sent 231 when a further third trigger signal comprising a further second identifier ID(CS(L_i_j)) for a further second MPC representation CS(L_i_j) of a further local machine learning model update L_i_j on the cluster of the aggregator 40 has been received from at least one further training client c_j (for another j) of the plurality/multitude C of the training clients c_j for the training iteration, wherein the fourth trigger signal comprises the further second identifier ID(CS(L_i_j)) (for the other j).

The fourth trigger signal can in particular be sent 231 when a respective third trigger signal comprising a respective second identifier ID(CS(L_i_j)) for a respective second MPC representation CS(L_i_j) of a respective local machine learning model update L_i_j on the cluster of the aggregator 40 has been received from each training client c_j of the plurality/multitude C of the training clients c_j for the training iteration, wherein the fourth trigger signal comprises each second identifier ID(CS(L_i_j)) (j=1 to m).

The method 200 can furthermore comprise checking 240, if a third identifier ID(CS(G_(i+1))) for a third MPC representation CS(G_(i+1)) of an aggregated machine learning model G_(i+1) on the cluster of the aggregator 40 has been received, whether a further training iteration is to be carried out for the aggregated machine learning model G_(i+1).

The method 200 can then furthermore comprise sending 241 the third identifier ID(CS(G_(i+1))) to an owner 10 of the machine learning model if no further training iteration is to be performed. Otherwise, the methods can be repeated for each further training iteration (for example, n training iteration), wherein, for example, ID(CS(G_(n−1))) is returned as the third identifier to the owner 10 of the machine learning model.

The methods 100, 200, 300, 400, 500 already protect the machine learning model against malicious training clients. Furthermore, they protect the machine learning model from being disclosed to the orchestrator 20. However, there is still a possible risk in that the orchestrator 20 can adversely affect the quality of the (trained) machine learning model through a maliciously distorted selection of training clients. This can be prevented as follows:

The method 200 can be performed within a trusted execution environment (TEE). This increases the certainty, in particular since the orchestrator 20 is prevented from maliciously deviating from the method 200 and/or the provided type. Here, the owner 10 of the machine learning model can trust, for example through remote attestation, that the orchestrator 20 will adhere to the predetermined selection strategy. A maliciously distorted selection of training clients can thus be prevented.

Furthermore, in the method 200, it is possible to confidentially log to an external memory, optionally to a distributed ledger. This can also increase the security since processes can also be tracked afterwards. Confidential logging can, for example, be realized by asymmetrically encrypting log entries with a public key of the owner 10 of the machine learning model.

Alternatively, the log entries can be encrypted with a private symmetric key that the orchestrator 20 and the owner 10 of the machine learning model have agreed in advance.

Furthermore, in the method 200, the orchestrator 20 can cause 250 at least one training client c_j to download the aggregated machine learning model G_(i+1) and to assess the quality of the aggregated machine learning model G_(i+1) on the basis of local test data of the training client (according to a predetermined local test criterion), wherein at least a second test result results, which is sent to the orchestrator 20.

Then, the method 200 can comprise receiving 251 the at least second test result.

Then, the method 200 can comprise cevaluating 252 the at least second test result as well as a first test result that results from a tester 50 designed to assess the quality of the aggregated machine learning model G_(i+1) on the basis of local test data of the tester 50 (likewise according to a predetermined test criterion), wherein the assessment is based on MPC or homomorphic encryption, wherein an evaluation result results.

The method 200 can then comprise performing 253 one or more predetermined actions depending on the evaluation result. A predetermined action may, for example, be that further training iterations are omitted because the evaluation result is already satisfactory. Alternatively, a predetermined action may, for example, also be to switch to another predetermined selection strategy for the training clients.

Furthermore disclosed is a computer-implemented method 300 for federated learning for a training client c_j, schematically shown in FIG. 1C.

The method 300 comprises downloading 320 a first MPC representation CS(G_i) of a machine learning model G_i from a cluster of an aggregator 40 on the basis of a first identifier ID(CS(G_i)) when a second trigger signal comprising the first identifier ID(CS(G_i)) has been received and identity and permission of the training client c_j have been verified on the cluster of the aggregator 40. Verifying the identity and permission of the training client can, for example, be based on a predetermined protocol for authentication and/or authorization.

The method 300 then comprises converting 321 the first MPC representation CS(G_i) of the machine learning model to a local machine learning model according to a predetermined MPC protocol (the same MPC protocol as in method 100). The local machine learning model may, for example, be the machine learning model G_i and, in particular, the initial machine learning model G_0. Alternatively, the local machine learning model may be a further representation of the machine learning model G_i (in particular G_0) designed for the training on the training client c_j.

The method 300 furthermore comprises training 330 the local machine learning model on the basis of local training data of the training client, wherein a local machine learning model update L_i_j is generated. The local machine learning model update L_i_j can, for example, be the trained local machine learning model.

The method 300 furthermore comprises converting 340 the local machine learning model update L_i_j to a second MPC representation CS(L_i_j) according to the predetermined MPC protocol.

The method 300 furthermore comprises uploading 342 a second secret sharing of the second MPC representation CS(L_i_j) of the local machine learning model update L_i_j to the cluster of the aggregator 40, wherein a second identifier ID(CS(L_i_j)) for the second MPC representation CS(L_i_j) of the local machine learning model update L_i_j on the cluster of the aggregator 40 is sent to the training client c_j.

The method 300 then comprises sending 343 a third trigger signal comprising the second identifier ID(CS(L_i_j)) to an orchestrator 20.

The method 300 can be performed (on at least one training client c_j or respectively on each training client c_j of the plurality C) within a trusted execution environment (TEE). This can ensure that one or more training clients c_j, preferably all training clients, cannot deviate from the method 300 (maliciously). This can, for example, prevent the machine learning model and in particular misuse thereof.[sic]¹

Furthermore disclosed is a computer-implemented method 400 for federated learning for an aggregator 40, illustrated schematically in FIG. 1D.

The method 400 comprises sending 410 a first identifier ID(CS(G_i)) for a first MPC representation CS(G_i) of a machine learning model G_i on a cluster of the aggregator 40 to an owner ¹ [Translator's note: Sentence may be missing something.]10 of the machine learning model G_i when a first secret sharing of the first MPC representation CS(G_i) is uploaded to the cluster of the aggregator 40.

The method 400 furthermore comprises sending 420 a second identifier ID(CS(L_i_j)) for a second MPC representation CS(L_i_j) of a local machine learning model update L_i_j on the cluster of the aggregator 40 to a training client c_j when a second secret sharing of the second MPC representation CS(L_i_j) is uploaded to the cluster of the aggregator 40.

The method 400 furthermore comprises securely aggregating 431, when a fourth trigger signal is received, a local machine learning model update L_i_j with at least one further local machine learning model update on the basis of a predetermined MPC circuit, wherein a third secret sharing of a third MPC representation CS(G_(i+1)) for an aggregated machine learning model G_(i+1) on a cluster of the aggregator 40 and a third identifier ID(CS(G_(i+1))) for the third MPC representation CS(G_(i+1)) result. Secure aggregating 431 can, for example, be realized by or be based on the algorithm from SAFELearn, see above. The aggregated machine learning model G_(i+1) can then be based on a weighting of local machine learning model updates L_i_j (for various j).

The method 400 then comprises sending 432 the third identifier ID(CS(G_(i+1))) to an orchestrator 20.

Alternatively, after n training iterations, an aggregated machine learning model CS(G_(n−1)) can be aggregated and a corresponding identifier ID(CS(G_(n−1))) can be sent 432 to the orchestrator 20.

The method 400 can furthermore comprise sending 440 the third identifier ID(CS(G_(i+1))) for the third MPC representation CS(G_(i+1)) to a tester 50, which is designed to download the aggregated machine learning model G_(i+1) and to assess the quality of the aggregated machine learning model G_(i+1) on the basis of local test data of the tester 50 (for example, according to a predetermined test criterion), wherein the assessment is based on MPC or homomorphic encryption, wherein a first test result results, which is sent to the aggregator 40.

The method 400 can then comprise receiving 441 the first test result.

The method 400 can then comprise sending 442 the first test result to the orchestrator 20. Depending on the first test result, one or more predetermined actions can be performed by the orchestrator 20 in the method 200, see above.

Alternatively, the assessment can be based on the machine learning model CS(G_(n−1)) aggregated after n training iterations.

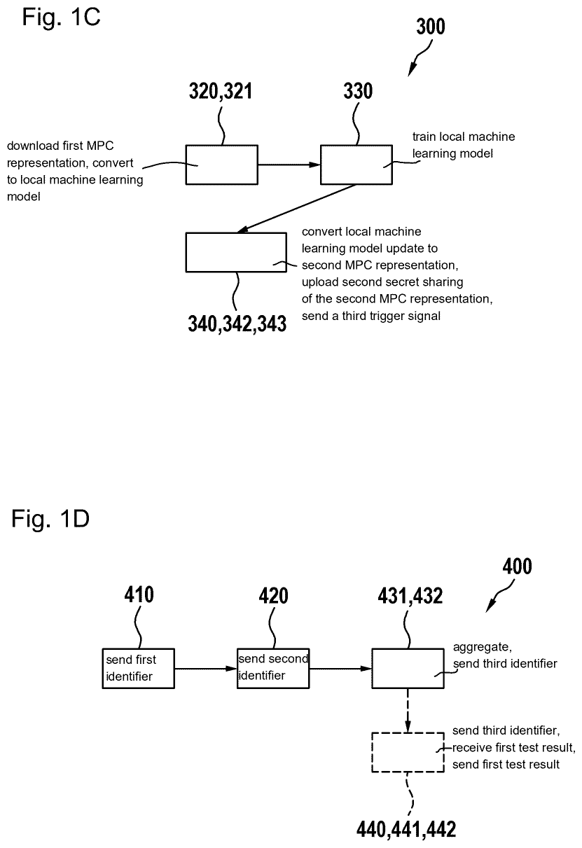

Furthermore disclosed are one or more combined methods 500, illustrated schematically in FIG. 2.

A method 500 can comprise the computer-implemented method 100 for federated learning for an owner 10 of a machine learning model. Alternatively, or additionally, the method 500 can comprise the computer-implemented method 200 for federated learning for an orchestrator 20. Alternatively, or additionally, the method 500 can comprise the computer-implemented method 300 for federated learning for a training client c_j. Alternatively, or additionally, the method 500 can comprise the computer-implemented method 400 for federated learning for an aggregator 40.

The predetermined MPC protocol in methods 100, 200, 300, 400, 500 can be based on fixed-point numbers, floating-point numbers, and/or integers (for example, int8 quantization). The selection can be made according to the desired compromise between performance and accuracy of the machine learning model. While a variant based on fixed-point numbers is faster but can possibly cause quantization errors, a variant based on floating-point numbers requires more computing power and also consumes more bandwidth (in the network) but makes a more accurate mapping between the original and the MPC-compatible representation of the machine learning model possible.

Alternatively, the methods 100, 200, 300, 400, 500 can be adapted such that the orchestrator 20 has access to the global machine learning model. In this variant, only the secure aggregation of the local machine learning model updates via MPC by the aggregator 40 takes place. Here, the exchange of the global machine learning model with the training clients takes place in-band, i.e., via regular communication channels.

Furthermore disclosed are one or more apparatuses, each of which is designed to perform one or more methods 100, 200, 300, 400, 500. Each of these apparatuses comprises at least one computing unit (at least one processor) and a working memory (for example, RAM) and may also comprise a non-volatile memory. An apparatus can, for example, comprise a computing unit for the owner 10 of the machine learning model. A further apparatus can, for example, comprise a computing unit for the orchestrator 20. One or more further apparatuses can, for example, each comprise at least one computing unit for a training client c_j. A further apparatus can, for example, comprise at least one computing unit (generally a multitude of computing units for the cluster) for the aggregator 40. An apparatus can furthermore comprise computing units for the owner 10 of the machine learning model, for the orchestrator 20, for each training client c_j, and/or for the aggregator 40. Such an apparatus can, for example, link the computing units in a network.

Furthermore disclosed are one or more computer programs, each of which is designed to perform one or more methods 100, 200, 300, 400, 500. Each of these computer programs can, for example, be present in interpretable or compiled form. For execution, it can be loaded (also in portions), for example as a bit sequence or byte sequence, into the working memory (for example, RAM) of an apparatus.

Furthermore disclosed are one or more data carriers or signals, which each contain or encode a disclosed computer program. The data carrier can, for example, comprise one of RAM, ROM, EPROM, HDD, SDD, . . . on/in which the signal is stored. A data carrier in which a computer program with the method 100, 200, 300, 400, 500 is stored can be a non-volatile memory of an apparatus.

What is claimed is:

1. A computer-implemented method for federated learning for an owner of a machine learning model, comprising the following steps:
uploading a first secret sharing of a first multi-party computation (MPC) representation of a machine learning model to a cluster of an aggregator, wherein a first identifier for the first MPC representation of the machine learning model on the cluster of the aggregator is sent to the owner; and
sending a first trigger signal including the first identifier to an orchestrator.

2. The method according to claim 1, further comprising:
converting the machine learning model to the first MPC representation according to a predetermined MPC protocol.

3. The method according to claim 2, further comprising:
downloading a third MPC representation of an aggregated machine learning model from the cluster of the aggregator based on the basis of a third identifier for the third MPC representation of the aggregated machine learning model on the cluster of the aggregator when the third identifier has been received;
converting the third MPC representation of the aggregated machine learning model to a global machine learning model according to the predetermined MPC protocol.

4. A computer-implemented method or federated learning for an orchestrator, comprising the following steps:
sending a second trigger signal including a first identifier for a first multi-party computation (MPC) representation of a machine learning model on a cluster of an aggregator to a plurality of training clients for a training iteration when a first trigger signal including the first identifier has been received; and
sending a fourth trigger signal including a second identifier for a second MPC representation of a local machine learning model update on the cluster of the aggregator to the aggregator when at least one third trigger signal including the second identifier for the second MPC representation of the local machine learning model update on the cluster of the aggregator has been received.

5. The method according to claim 4, further comprising:
selecting the plurality of the training clients for the training iteration according to a predetermined selection strategy.

6. The method according to claim 4, wherein the fourth trigger signal is sent when a further third trigger signal including a further second identifier for a further second MPC representation of a further local machine learning model update on the cluster of the aggregator has been received for the training iteration from at least one further training client of the plurality of the training clients; and wherein the fourth trigger signal includes the further second identifier.

7. The method according to claim 4, wherein the fourth trigger signal is sent when a respective third trigger signal including a respective second identifier for a respective second MPC representation of a respective local machine learning model update on the cluster of the aggregator has been received for the training iteration from each training client of the plurality of the training clients; and wherein the fourth trigger signal includes each respective second identifier.

8. The method according to claim 4, further comprising:
checking, when a third identifier for a third MPC representation of an aggregated machine learning model on the cluster of the aggregator has been received, whether a further training iteration is to be carried out for the aggregated machine learning model;
sending the third identifier to an owner of the machine learning model when no further training iteration is to be carried out.

9. The method according to claim 4, wherein the method is performed within a trusted execution environment.

10. The method according to claim 4, wherein logging takes place confidentially on an external memory.

11. The method according to claim 4, wherein the orchestrator causes at least one of the training clients to download the aggregated machine learning model and to assess a quality of the aggregated machine learning model based on a local test data of the training client, wherein at least a second test result results, which is sent to the orchestrator; and the method further comprises:
receiving the at least second test result;
evaluating the at least second test result as well as a first test result that results from a tester configured to assess a quality of the aggregated machine learning model based on local test data of the tester, wherein the assessment is based on MPC or homomorphic encryption, and wherein an evaluation result results;
performing a predetermined action depending on the evaluation result.

12. A computer-implemented method for federated learning for a training client, comprising the following steps:
downloading a first multi-party computation (MPC) representation of a machine learning model from a cluster of an aggregator based on a first identifier when a second trigger signal including the first identifier has been received, and identity and permission of the training client have been verified on the cluster of the aggregator;
converting the first MPC representation of the machine learning model to a local machine learning model according to a predetermined MPC protocol;
training the local machine learning model based on local training data of the training client, wherein a local machine learning model update is generated;
converting the local machine learning model update to a second MPC representation according to the predetermined MPC protocol;
uploading a second secret sharing of the second MPC representation of the local machine learning model update to the cluster of the aggregator, wherein a second identifier for the second MPC representation of the local machine learning model update on the cluster of the aggregator is sent to the training client; and
sending a third trigger signal including the second identifier to an orchestrator.

13. The method according to claim 12, wherein the method is performed within a trusted execution environment.

14. A computer-implemented method for federated learning for an aggregator, comprising the following steps:
sending a first identifier for a first multi-party computation (MPC) representation of a machine learning model on a cluster of the aggregator to an owner of the machine learning model when a first secret sharing of the first MPC representation is uploaded to the cluster of the aggregator;
sending a second identifier for a second MPC representation of a local machine learning model update on the cluster of the aggregator to a training client when a second secret sharing of the second MPC representation is uploaded to the cluster of the aggregator;
securely aggregating, when a fourth trigger signal is received, a local machine learning model update with at least one further local machine learning model update based on a predetermined MPC circuit, wherein a third secret sharing of a third MPC representation for an aggregated machine learning model on the cluster of the aggregator and a third identifier for the third MPC representation result; and
sending the third identifier to an orchestrator.

15. The method according to claim 14, wherein the aggregated machine learning model is based on a weighting of local machine learning model updates.

16. The method according to claim 14, further comprising:
sending the third identifier for the third MPC representation to a tester, which is configured to download the aggregated machine learning model and to assess a quality of the aggregated machine learning model based on local test data of the tester, wherein the assessment is based on MPC or homomorphic encryption, and wherein a first test result results, which is sent to the aggregator;
receiving the first test result;
sending the first test result to the orchestrator.

17. The method according to claim 2, wherein the predetermined MPC protocol is based on fixed-point numbers, floating-point numbers, and/or integers.

18. Apparatus for federated learning for an owner of a machine learning model, the apparatus configured to:
upload a first secret sharing of a first multi-party computation (MPC) representation of a machine learning model to a cluster of an aggregator, wherein a first identifier for the first MPC representation of the machine learning model on the cluster of the aggregator is sent to the owner; and
send a first trigger signal including the first identifier to an orchestrator.

19. A non-transitory computer-readable medium on which is stored a computer program for federated learning for an owner of a machine learning model, the computer program, when executed by a computer, causing the computer to perform the following steps:
uploading a first secret sharing of a first multi-party computation (MPC) representation of a machine learning model to a cluster of an aggregator, wherein a first identifier for the first MPC representation of the machine learning model on the cluster of the aggregator is sent to the owner; and
sending a first trigger signal including the first identifier to an orchestrator.
